(19) United States
(12) Patent Application Publication
(10) Pub. No.: US 2022/0171601 A1
(43) Pub. Date: Jun. 2, 2022

(54) ELECTRONIC ARCHITECTURE AND SEMICONDUCTOR DEVICES BASED ON A BASE 60 NUMERAL SYSTEM

(71) Applicants: Danny Rittman, San Diego, CA (US); Mo Jacob, Beverly Hills, CA (US)

(72) Inventors: Danny Rittman, San Diego, CA (US); Mo Jacob, Beverly Hills, CA (US)

(21) Appl. No.: 17/109,889

(22) Filed: Dec. 2, 2020

(51) Int. Cl. G06F 7/49

(52) U.S. Cl. CPC G06F 7/49

(57) ABSTRACT

Sexagesimal-native electronic architecture and methods are provided including a sexagesimal-native semiconductor unit natively performing operations and flows using a numeral system having sixty as its base. The semiconductor unit may be an integrated circuit, an arithmetic logic unit, a central processing unit, a microcontroller, or a microchip. The sexagesimal-native semiconductor unit is configured to communicate with semiconductor units that perform operations and flows using decimal and/or binary number systems. A sexagesimal numeral method provides a sexagesimal-native arithmetic operation unit performing mathematical operations using a numeral system having sixty as its base wherein all numbers are natively processed and represented as sexagesimal numbers. A sexagesimal-native integrated circuit performs operations using a Base 60 numeral system and is configured to communicate with integrated circuits that perform operations using decimal and/or binary number systems also is provided. In exemplary sexagesimal-native electronic architecture, the chip can work with other similar chips in parallel processing mode.

### FIELD

The present disclosure relates to sexagesimal-native devices, methods, and electronic architecture that perform operations using Base 60, a numeral system having sixty as its base.

### BACKGROUND

Sumer (a region of Mesopotamia, in modern-day Iraq) was the birthplace of writing, the wheel, agriculture, the arch, the plow, irrigation and many other innovations, and often is referred to as “the Cradle of Civilization.” The Sumerians developed the earliest known writing system—a pictographic system known as cuneiform script, using wedge-shaped characters inscribed on baked clay tablets—and this has meant that we actually have more knowledge of ancient Sumerian and Babylonian mathematics than of early Egyptian mathematics. Indeed, we even have what appear to have been school exercises in arithmetic and geometric problems.

Sumerian and Babylonian mathematics was based on a sexagesimal, or base 60, numeric system, which could be counted physically using the twelve knuckles on one hand and the five fingers on the other hand. Unlike those of the Egyptians, Greeks and Romans, Babylonian numbers used a true place-value system, where digits written in the left column represented larger values, much as in the modern decimal system, although of course using base 60 not base 10. Thus, [symbol] in the Babylonian system represented 3,600 plus 60 plus 1, or 3,661. Also, to represent the numbers 1-59 within each place value, two distinct symbols were used, a unit symbol ( [symbol] ) and a ten symbol ( [symbol] ), which were combined in a similar way to the familiar system of Roman numerals (e.g. 23 would be shown as [symbol] ). Thus, [symbol] represents 60 plus 23, or 83. However, the number 60 was represented by the same symbol as the number 1 and, because they lacked an equivalent of the decimal point, the actual place value of a symbol often had to be inferred from the context.

Fast forward to today when electronic devices have become commodities in society. The heart of every electronic device is a microchip or, as it called, an integrated circuit (IC). The development of IC technology is driven by the need to increase both performance and functionality while reducing power and cost. This goal has been achieved by two solutions: scaling devices and associated interconnecting wire. This is done through the implementation of new materials and processing innovations and through introducing architectural enhancements to reconfigure routing, hierarchy, and placement of critical circuit building blocks.

The constant increasing demand for arithmetic performance in modern computing, neural networks, and big data are dominating the requirements for next-generation computing systems and methods. A typical CPU, GPU or microcontroller main design goal is to satisfy the high demand for computing power within lower power. Shrinking transistor size enables packing billions of transistors on silicon wafers. Typically, integrated circuits make calculations and process information using decimal and binary notation. However, the common decimal and binary systems are limited in speed and accuracy, especially for arithmetic and logic operations. The basic, traditional, numerical processing design remains within the decimal method which has reached its limits.

Accordingly, there is a need for integrated circuits and other semiconductor units that utilize a different numeral system to provide faster and more accurate calculations. There is a need for new numeral methodology and architecture that will process information more quickly and provide more accurate results.

### SUMMARY

The present disclosure, in its many embodiments, alleviates to a great extent the disadvantages of known devices, systems, and methods by providing new system architecture, semiconductor units, and arithmetic operation units that natively work in sexagesimal or Base 60 method. The present disclosure relates to an integrated circuit and an Arithmetic Logic Unit (ALU) that processes calculations in Base 60 method, also known as the Sexagesimal system. The present disclosure further relates to a new concept of processing arithmetic, logic operations using the Base 60 or Sexagesimal system.

Generally, the present disclosure relates to integrated circuits which can make calculations and information processing using decimal and binary notation. However, the present disclosure describes a new concept which is a Sexagesimal-native microchip architecture, ALU (Arithmetic Logic Unit) and/or CPU (Central Processing Unit) system and method. These new integrated circuit calculations and processing methods enhance computing speed and performance. While current integrated circuit processing units (ALU, CPU, Microcontrollers, Mathematical related circuits) use decimal and binary number systems only, exemplary embodiments provide a Sexagesimal native integrated circuit architecture (ALU, CPU, Microcontroller, math related microchips).

As discussed in more detail herein, exemplary integrated circuits or any other semiconductor units like ALU, CPU, Microcontroller, or any other arithmetic circuit natively works in sexagesimal or Base 60 method. This is done to achieve faster speed and better accuracy for arithmetic and/logic operations. Computing systems using disclosed embodiments gain exponential calculations/logic operation speed enhancement and much higher accuracy. The Base 60 approach described herein can achieve faster numerical processing within low power consumption range.

Every processor in a laptop/computer is built on binary arithmetic operations. When we do normal decimal (base10) arithmetic operations in a typical, standard microprocessor or any chip that requires computations, variables values are converted from decimal (Base 10) to binary, operations are executed, then the result of the binary arithmetic operation is converted back to decimal. This is the basic working of an ALU in processors. There is currently no processor built to work with Base 60 arithmetic operations, natively.

Exemplary embodiments of a sexagesimal-native electronic architecture comprise a sexagesimal-native semiconductor unit natively performing operations and flows using a numeral system having sixty as its base. The semiconductor unit may be an integrated circuit, an arithmetic logic unit, a central processing unit, a microcontroller, or a microchip. The operations and flows may include arithmetic calculations and/or logic operations. In exemplary embodiments, the semiconductor unit calculates and processes the arithmetic calculations and logic operations in Base 60 digits. The sexagesimal-native semiconductor unit is configured to communicate with semiconductor units that perform operations and flows using decimal and/or binary number systems. The semiconductor unit utilizes circuitry and an internal machine language to calculate and process the arithmetic calculations and logic operations.

In exemplary embodiments, op-codes are stored and processed internally using the numeral system. Exemplary architecture may have a three-dimensional multi-planar silicon structure. The architecture may further comprise one or more of an onboard memory unit, a microcontroller unit, low power circuitry, a register, an 110 unit, a clock generator, and/or a power management unit. In exemplary embodiments, the architecture further comprises at least one bipolar transistor and at least one field-effect transistor and one or both of the bipolar transistor and field-effect transistor forms digital analog or mixed signal circuits. The architecture may include a write bus, one or more registers, and a memory buffer communicatively connected to the write bus between the semiconductor unit and the one or more registers.

Also disclosed is a sexagesimal-native integrated circuit performing operations using a Base 60 numeral system. The sexagesimal-native integrated circuit is configured to communicate with integrated circuits that perform operations using decimal and/or binary number systems. The sexagesimal-native integrated circuit comprises a Base 60-native integer computing system and may further comprise a Base 60-native fixed-point computing system.

Sexagesimal numeral methods are also provided. Exemplary methods comprise providing a sexagesimal-native arithmetic operation unit performing mathematical operations using a numeral system having sixty as its base. In disclosed methods, all numbers are natively processed and represented as sexagesimal numbers. The sexagesimal-native arithmetic operation unit is configured to communicate with arithmetic operation units that perform mathematical operations using decimal and/or binary number systems. The arithmetic operation unit may be an integrated circuit, an arithmetic logic unit, a central processing unit, a microcontroller, or a microchip. In exemplary embodiments, the arithmetic operation unit works in operational levels including a first level being a read operation and a last level being output/write operation.

The arithmetic operation unit may be configured to convert the numeral system to a decimal system and/or a binary system and configured to convert either of the decimal system and the binary system back to the numeral system having sixty as its base. Exemplary methods further comprise storing input and output data in one or more registers as high or low voltage levels. Exemplary methods may further comprise a memory buffer generating a drive level on the one or more registers.

In exemplary sexagesimal-native electronic architecture, the chip can work with others similar chips in parallel processing mode. The architecture may include multiple ALUs working in parallel to achieve high performance. In exemplary embodiments, the sexagesimal-native electronic architecture and system includes multi-core controllers on-board. The sexagesimal-native electronic architecture and system ALU may be divided into two units, an arithmetic unit (AU) and a logic unit (LU). In exemplary embodiments, the sexagesimal-native electronic architecture and system includes two AUs, one for fixed-point arithmetic operations and another for floating-point arithmetic operations. The sexagesimal-native electronic architecture and system can be set by users with customized programmatic setup algorithms for efficient parallel processing operations.

Accordingly, it is seen that sexagesimal-native integrated circuits, architecture, and methods are provided. These and other features of the disclosed embodiments will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a block diagram of an exemplary embodiment of a sexagesimal-native electronic architecture in accordance with the present disclosure;

FIG. 2 is a block diagram of an exemplary embodiment of a sexagesimal-native electronic architecture in accordance with the present disclosure;

FIG. 3 is a block diagram of an exemplary embodiment of a sexagesimal-native electronic architecture in accordance with the present disclosure;

FIG. 4 is process flow diagram of an exemplary embodiment of a sexagesimal numeral method in accordance with the present disclosure;

FIG. 5 is a process flow diagram of an exemplary embodiment of a sexagesimal-native electronic architecture in accordance with the present disclosure;

FIG. 6 is process flow diagram of an exemplary embodiment of a sexagesimal numeral method in accordance with the present disclosure;

FIG. 7 is process flow diagram of an exemplary embodiment of a method for conversion to decimal flow in accordance with the present disclosure;

FIG. 8 is a system diagram of an exemplary embodiment of a sexagesimal numeral method in accordance with the present disclosure;

FIG. 9 is a system diagram of an exemplary embodiment of a sexagesimal numeral method and method for conversion to decimal flow in accordance with the present disclosure; and

FIG. 10 is a process flow diagram of an exemplary embodiment of a sexagesimal numeral method and parallel processing method in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure.

As used herein, the “present disclosure” refers to any one of the embodiments described herein, and any equivalents. Furthermore, reference to various aspects of the disclosure throughout this document does not mean that all claimed embodiments or methods must include the referenced aspects. Reference to materials, configurations, directions, and other parameters should be considered as representative and illustrative of the capabilities of exemplary embodiments, and embodiments can operate with a wide variety of such parameters. It should be noted that the figures do not show every piece of equipment, nor the materials, configurations, and directions of the various circuits and communications systems.

In the present disclosure and its embodiments we present electronic architecture, semiconductor units/arithmetic operation units, including but not limited to, integrated circuits and derivative circuits like ALU, CPU and other processing circuits, that are Base 60 native. In exemplary embodiments, the semiconductor unit/arithmetic operation unit is a microcontroller unit of digital, analog, or mixed signal style. As discussed in more detail herein, all digits are sexagesimal and represented as sexagesimal numbers natively. The architecture and semiconductor units/arithmetic operation units perform arithmetic calculations, logic operations and flows using a numeral system with sixty as its base. Performing Base 60 operations natively means that disclosed architecture and semiconductor/arithmetic operation units do not convert to a decimal/binary system and then do calculations but instead natively perform all calculations in Base 60 by design.

A Base 60 native numeral system is advantageous because the number 60 is what is known in mathematics as a superior highly composite number, a natural number having more divisors than any other number scaled relative to some positive power of the number itself. Sixty, in particular, has twelve factors—1, 2, 3, 4, 5, 6, 10, 12, 15, 20, 30, and 60—of which 2, 3, and 5 are prime numbers. Due to these many factors, many fractions involving the number 60 are simplified. For example, one hour can be divided evenly into sections of 30 minutes, 20 minutes, 15 minutes, 12 minutes, 10 minutes, 6 minutes, 5 minutes, 4 minutes, 3 minutes, 2 minutes, and 1 minute. Sixty also is the smallest number that is divisible by every number from 1 to 6, i.e., it is the lowest common multiple of 1, 2, 3, 4, 5, and 6.

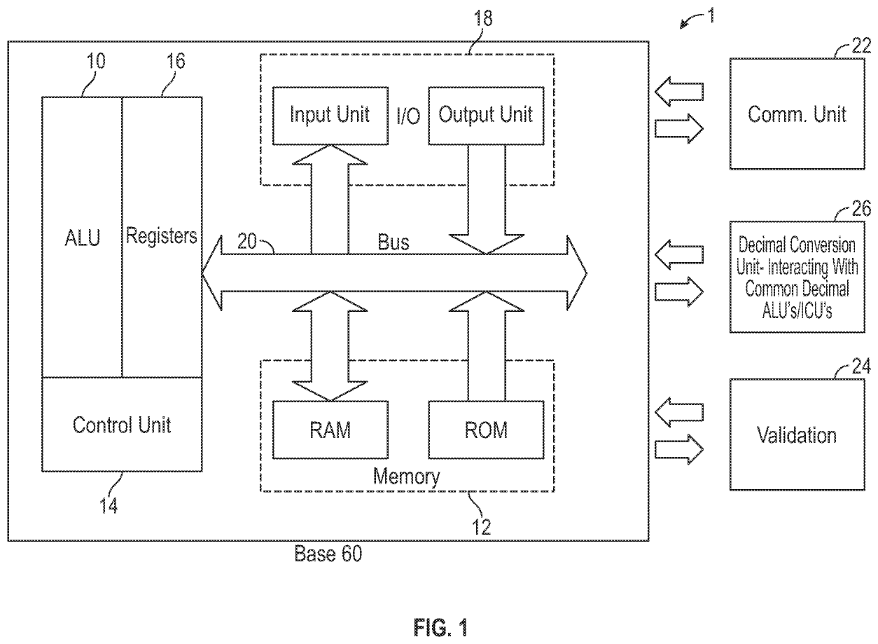

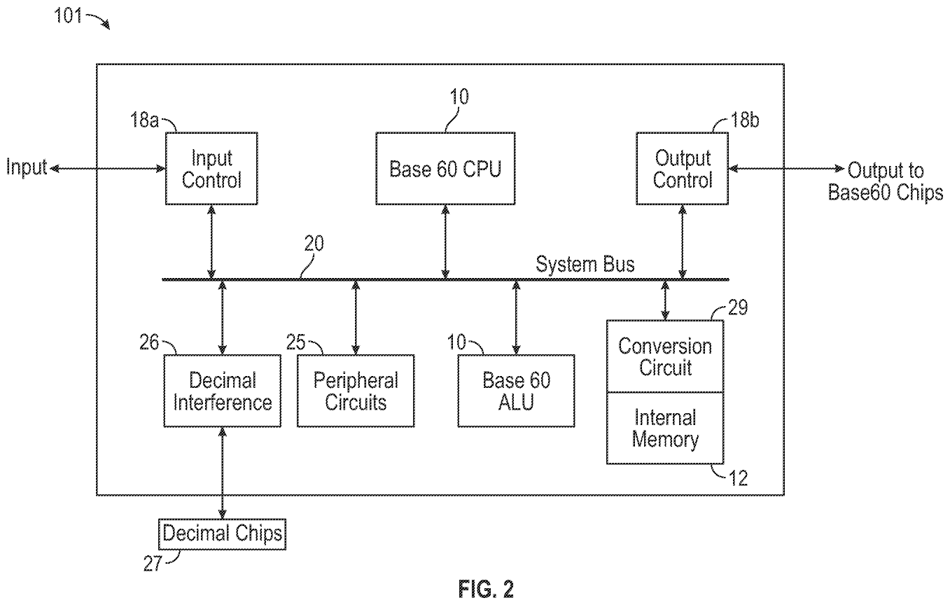

With reference to FIGS. 1-4, exemplary sexagesimal-native electronic architecture 1, 101, 151 will be described. The architecture includes semiconductor/arithmetic operation unit 10 that natively performs all operations and flows using a numeral system having sixty as its base. The semiconductor/arithmetic operation unit 10 could be a CPU and/or an ALU. In FIG. 1, the semiconductor/arithmetic operation unit 10 is an ALU, and the embodiment illustrated in FIG. 2 comprises a CPU and an ALU. The operations and flows of the semiconductor unit 10 include arithmetic calculations and logic operations. In its operations and flows, all sexagesimal digits are represented and processed as Base 60 numbers, except where otherwise noted. For example, “10” means the number ten and “60” means the number sixty. Thus, the semiconductor unit 10 calculates and processes the arithmetic calculations and logic operations in Base 60 digits. In addition, op-codes are stored and processed internally using the Base 60 numeral system.

In exemplary embodiments, the semiconductor unit 10 utilizes circuitry and an internal machine language to calculate and process the arithmetic calculations and logic operations. The arithmetic processing unit 10 may include an integer computing system and method and/or a fixed-point computing system and method which are Base 60 native. A data processing system to perform addition, subtraction, multiplication, and division of numbers comprising sets of digits in sexagesimal method is also provided. The architecture and arithmetic operation unit are configured to convert the numeral system to a decimal system and/or a binary system and to convert back to the sexagesimal system.

The arithmetic operation unit 10 may have a complete processor microchip or a portion of a processor microchip integrated on one semiconductor substrate. As would be understood by those of skill in the art, additional components of the architecture 1, 101, 151 may include an onboard memory unit 12, a microcontroller unit 14, low power circuitry, one or more registers 16, an I/O unit 18 (including input control 18a and output control 18b), peripheral circuits 25, a clock generator, and a power management unit. A bipolar transistor and field-effect transistor may be provided to form digital, analog, or mixed signal circuits.

As discussed in more detail herein, a decimal conversion unit or interface 26 is provided for conversion to decimal flow and for communication with existing chips 27 that operate in standard decimal and/or binary language. A conversion circuit 29 may be provided and utilized for the decimal or binary conversion. Exemplary architecture also includes a system bus or write bus 20 and one or more registers 16 with a memory buffer coupled to the write bus between the semiconductor unit and the registers. The memory buffer generates the drive level on the write bus for the registers. Input and/or output data may be stored in the registers as “high” and “low” voltage levels.

In exemplary embodiments, the semiconductor unit is an integrated circuit. The sexagesimal native integrated circuit performs arithmetic operations using input/output data in sexagesimal base. Advantageously, using Base 60 as an integrated circuit native calculation method enhances the computing accuracy and speed of the circuit. More particularly, the integrated circuit provides a new break-through computing method to achieve a significant performance increase when it comes to digital or analog processing of arithmetic, and logic operations. In exemplary embodiments, the integrated circuit comprises a 3D, multi-planar silicon structure. An onboard memory unit and microcontroller unit manage all the calculations.

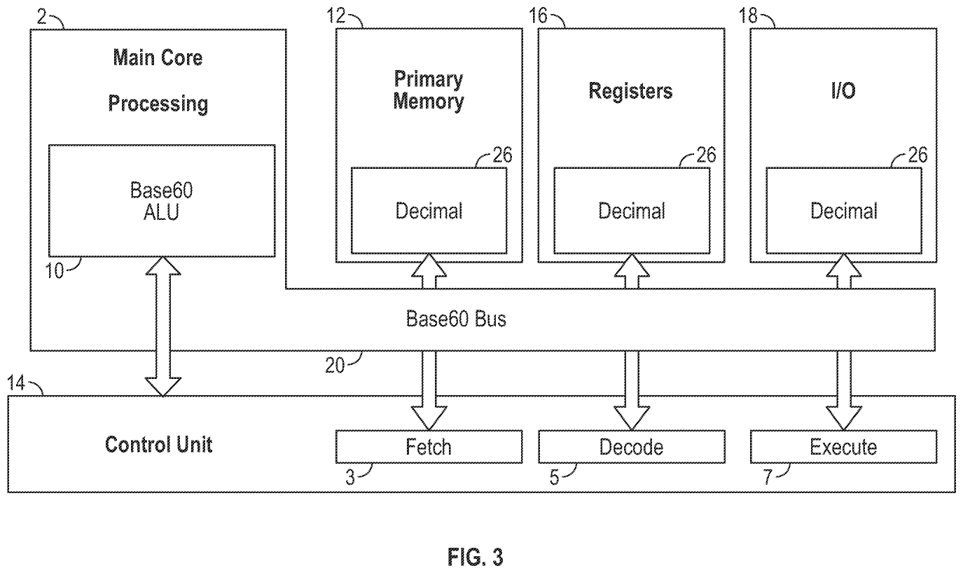

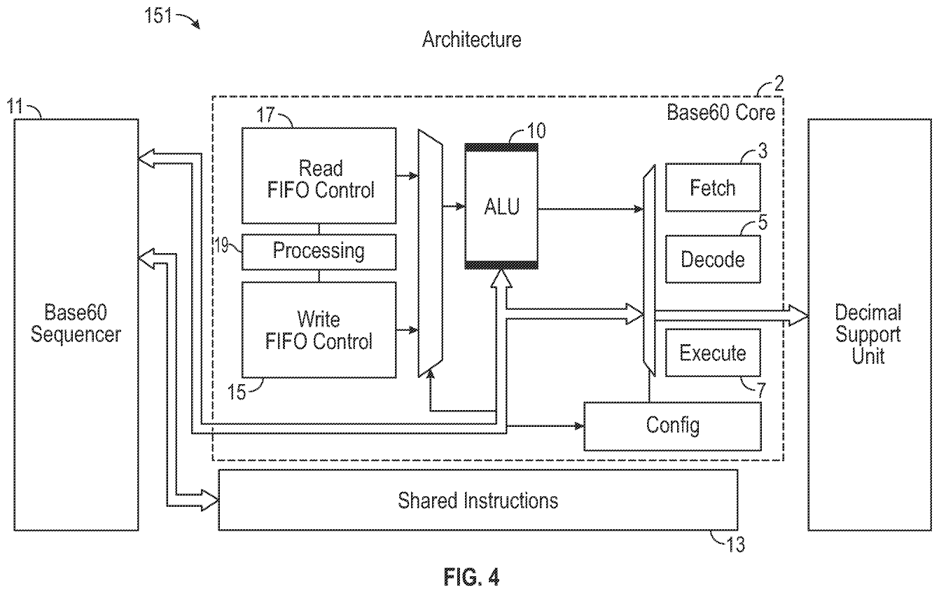

The diagrams in FIGS. 3 and 4 illustrate exemplary chip core structure and architecture 151. In exemplary embodiments, the main core processing section 2 performs all Base 60 instructions. The primary memory 12, registers 16, and Input/Output 18 may each include an internal decimal conversion unit 26 and decode/encode from Base 60 to decimal when needed. The Base 60 bus 20 connects all the major units for all Base 60 arithmetic and logic operations. Bus 20 is the communication channel for all data, i.e., the data flow channel where all operands are handled.

The Base 60 Sequencer 11 controls the calculation flow. It gets Shared Instructions 13 about conducting a calculation in Base 60 or Decimal method and directly commands the ALU unit 10 to perform the operation. The ALU unit 10 gets the data using FIFO (First In First Out) 15 method from the Read Control Unit 17. The ALU produces results to the Write Control (Same in FIFO method). One of the advantages of the disclosed system is that the Read and Write Control Units 17, 15 are working in conjunction through a processing unit 19, to perform Base 60 operations. The processing unit 19 performs parallel execution for Read/Write operations and does conversions in case of Decimal data. The Fetch 3, Decode 5, Execute units 7 work with the Decimal Support unit and can be configured for different setups using a dedicated Configuration unit (Config) 9. As described with reference to other figures, operations are stored in the chip's local memory, pass through the system Registers, Multiplexers (Muxs) and Arithmetic Logic Unit (ALU).

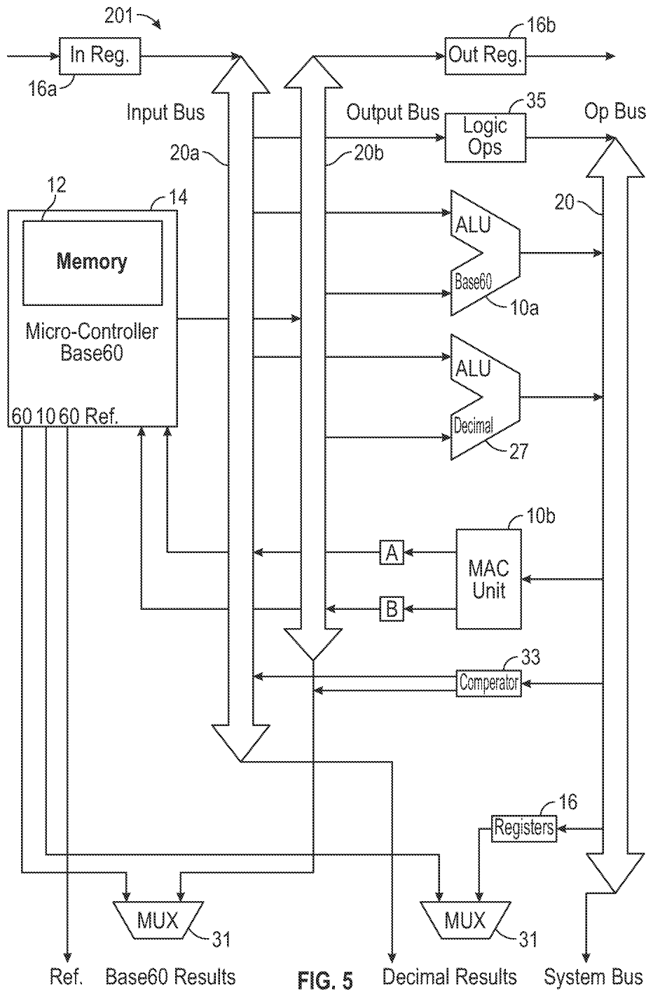

Turning to FIG. 5, an exemplary embodiment of sexagesimal-native electronic architecture 201 will now be described. The architecture 201 is composed of one or more registers 16, including an in register 16a and an out register 16b, one or more buses 20, including input bus 20a and output bus 20b, and one or more multiplexers 31. The sexagesimal-native semiconductor unit may comprise an internal Arithmetic Logical Unit (ALU) 10a and/or a Multiply and Accumulate (MAC) unit 10b. In exemplary embodiments, a comparator 33 and a Logic Operations unit 35 are also provided. There could also be a decimal ALU 27 to perform operations using decimal numbers.

FIG. 5 illustrates the block level organization of the architecture 201. The ALUs 10a, 27 perform the operations on data needed to implement arithmetic operations in Base 60 and Decimal. The Logic Ops unit 35 carries out Logic operations in Base 60 and Decimal. For arithmetic efficiency, the architecture uses internal synchronous (embedded) memory for both data and instruction storage. The instruction memory is addressable through the Micro-Controller 14, which contains a memory 12 and is configured to perform a fetch, decode and execute operation for instructions. In exemplary embodiments, Micro-Controller 14 is a complex Finite State Machine (FSM) which is organized as a series of procedures to maximize customization and functionalities.

In exemplary embodiments, Micro-Controller 14 produces Base 60, Decimal and Reference instructions for conversions between Base 60 and Decimal. The MAC unit 10b multiplies corresponding Base 60 elements of two sequences of numbers which are provided via the two separate buses (Input Bus 20a, Output Bus 20b) and accumulates the sum of the products in a single clock cycle. The comparator unit 33 is used to perform Base 60 to binary conversion, as well as to verify operations. The multiplexers 31 produce the final results, switching several inputs into a single output. The System Bus 20 is used for internal instructions execution.

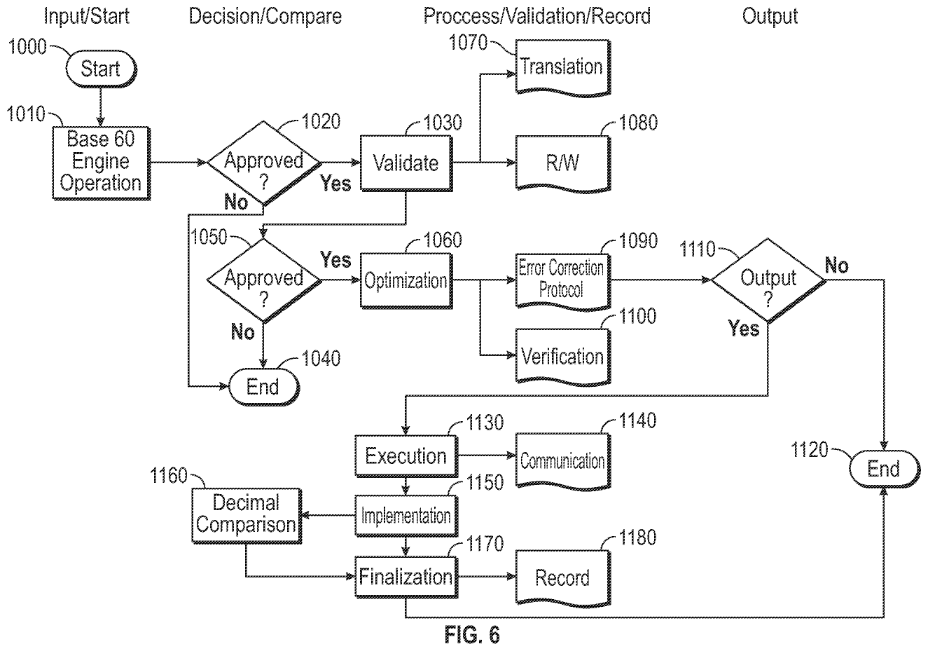

In operation, an exemplary sexagesimal numeral method process flow is illustrated in FIG. 6. As discussed above, exemplary architecture includes circuitry and an internal machine language that natively performs operations and flows using a Base 60 numeral system. That is, it calculates and processes the arithmetic calculations and logic operations using sexagesimal numbers without first converting to a decimal/binary system. An exemplary process has four stages: Input/Start, Decisions/Compare, Processing/Validation/Record, and Output.

At the start 1000 the sexagesimal architecture receives a request for a mathematic/arithmetic/logic operation and performs the Base 60 engine operation 1010. If the operation is approved 1020, operations move on to the Processing/Validation/Record stage in which the architecture processes the requested operation, validates, executes, and communicates the results to other chips, in some embodiments utilizing communication sub-unit 22 onboard More particularly, the architecture then validates 1030 the results. If the operation is not approved, the operation ends 1040. After validation 1030, the architecture may perform translation 1070 and read/write operations 1080. After validation 1030, the operation may be approved again 1050. Then the architecture performs optimization 1060, error correction 1090 and/or verification 1100.

If all operations are approved valid by validation unit 24, after the error correction protocol 1090, then results are outputted. Once operations are optimized and any errors corrected, if results are outputted 1110, another series of steps may be performed. If there is no output 1110, the operations end 1120. If there is output 1110 of results, the architecture goes on to an execution step 1130 followed by communication 1140 or implementation 1150. The implementation step 1150 may lead to decimal comparison 1160, if requested. After the comparison to decimal 1160 or implementation step 1150, the architecture performs a finalization step 1170 to finalize the results and may record 1180 the results or end 1120 the operations.

During operations, the semiconductor/arithmetic operation unit may work in more than one operational level. For example, the levels may include a first level that is a read operation and a last level that is an output/write operation. In exemplary embodiments, the numeral system is converted to a decimal system and/or a binary system during operations and may be converted back to the Base 60 numeral system internally. Input and/or output data may be stored in registers as “high” and/or “low” voltage levels and processed as sexagesimal status. A memory buffer may generate a drive level on the registers.

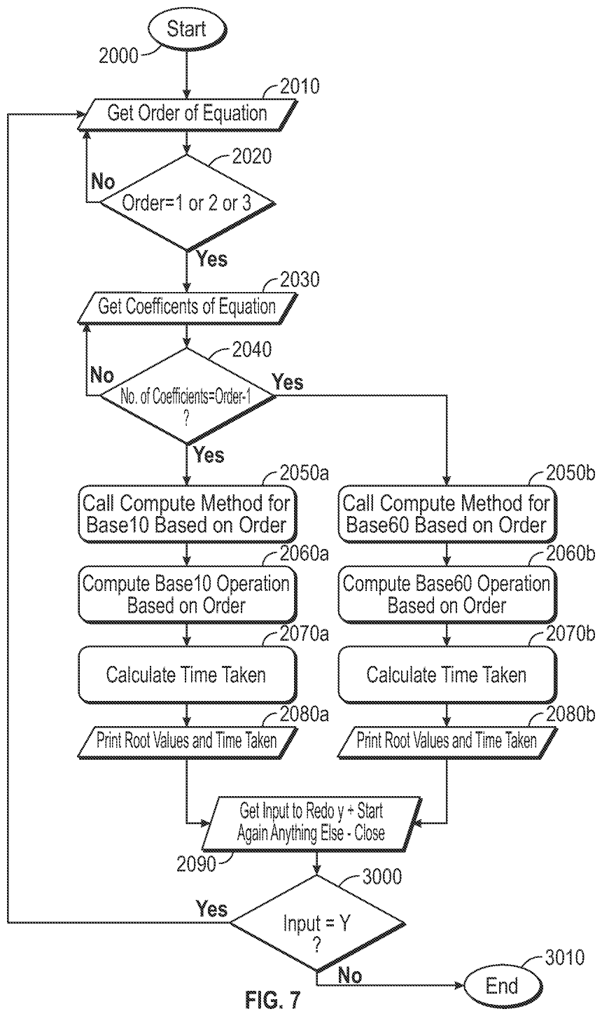

Turning to FIG. 7, an exemplary process for conversion to decimal flow will now be described. These steps may be performed by a decimal conversion unit 26 or circuit 29 (shown in FIGS. 1-3). The conversion to decimal and calculations in decimal flow advantageously show the speed differences between the decimal and sexagesimal methods. It also facilitates interaction with existing chips that “speak” standard decimal and/or binary language. Thus, when the sexagesimal architecture and semiconductor unit needs to interact with a typical decimal chip, it will be able to do that. The sexagesimal chip will be able to work with its own type chips (Base 60) and produce fast results to decimal chips.

At the start 2000, the architecture gets the order of the equation 2010. If the order is not 1, 2 or 3 (step 2020), the flow returns to the first step 2010. If the order is 1, 2 or 3 (step 2020), the architecture gets the coefficients of the equations 2030. If the number of coefficients does not equal order+1 (step 2040), the flow returns to step 2030. If the number of coefficients equals order+1 (step 2040), the flow branches into two parallel flows, one for a Base 10 method and the other for the Base 60 method.

The Base 10 method flow includes the step 2050a of calling a compute method for Base 10 based on the order, then computing Base 10 operation based on order (step 2060a). Then the architecture calculates the time taken (step 2070a) and prints the root (step 2080a). Similarly, the Base 60 method flow includes calling a compute method for Base 60 based on the order (step 2050b). Next, Base 60 operation is computed based on the order (step 2060b). The architecture then calculates the time taken (step 2070b) and prints the root (step 2080b).

After the parallel Base 10 and Base 60 process flows, the conversion to decimal flow gets input to redo and start again (step 2090), where the process converts digit after digit until it is done. Also, at step 2090, the architecture queries whether there is anything else to convert, essentially repeating the process until the conversion is complete. At this point the process closes, also in step 2090. The conversion is done in a methodical way, as calculating one segment, shifting to the next one, and repeating the calculation. When all digits are calculated, the conversion is complete. More particularly, once all digits are processed the architecture completes the conversion and halts, waiting for another conversion. If an additional input is produced, the flow returns to step 2010 to get the order of the equation. If not, the process stops (3010).

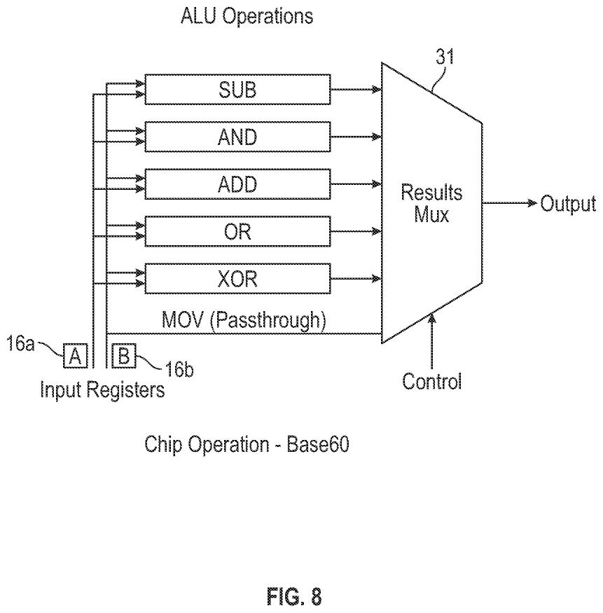

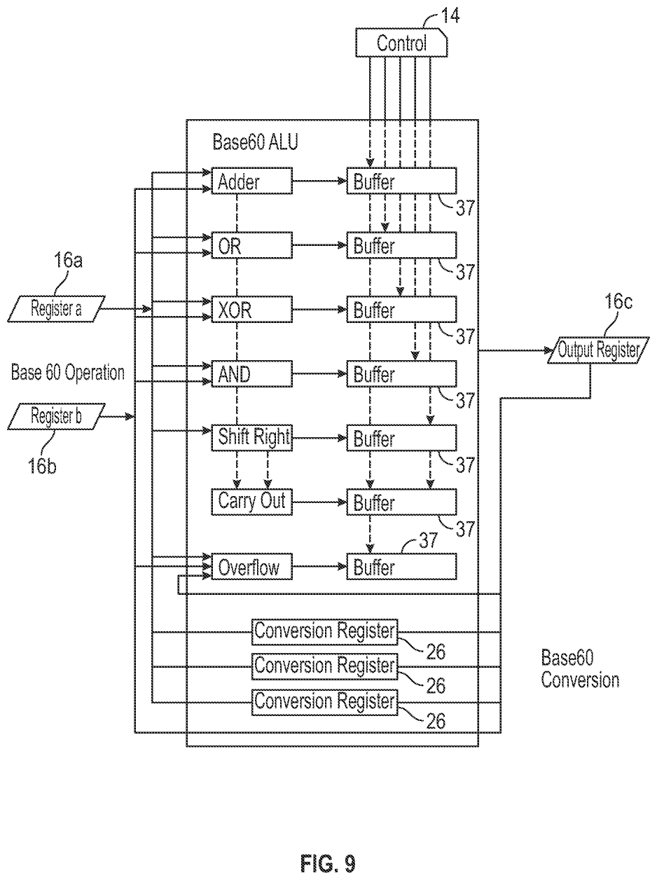

With reference to FIGS. 8 and 9, exemplary Base 60 operations are illustrated by way of system diagrams. Input enters via input registers 16a and 16b and results exit via output register 16c. In exemplary embodiments, the two inputs, A and B, are both 32-bit values. Buffers 37 may be used to isolate the input from the output. The control unit 14 identifies the operation that needs to be done (Calculated). The basic commands are shown in blocks and include SUB, AND, ADD, OR, and XOR. MOV indicates a passthrough operation. A Shift Right command and Carry Out command also are provided. The Carry bit is produced in case a leftover bit is produced. The results flow through multiplexer 31 and are then output. In exemplary embodiments, Base 60 flow utilizes three conversion registers 26 to perform an internal conversion to decimal (if needed). If the communication is done among similar Base 60 chips, these registers are not used.

In exemplary embodiments, the basic operation of the Base 60 ALU is like the case flow shown in FIG. 9. An exemplary flow command sequence is as follows:

case(CONTROL[3:0])
4′b0000:{CARRY,OUTPUT } <= {1′b0,A}-{1′b0,B};// SUB
4′b0001: OUTPUT <= A & B; // And
4′b0010:{CARRY,OUTPUT } <= A + B; // Add
4′b0011: OUTPUT <= A | B; // Or
4′b0100: OUTPUT <= A \hat{ } B; // Xor
// ....
default: OUTPUT <= B; // MOV

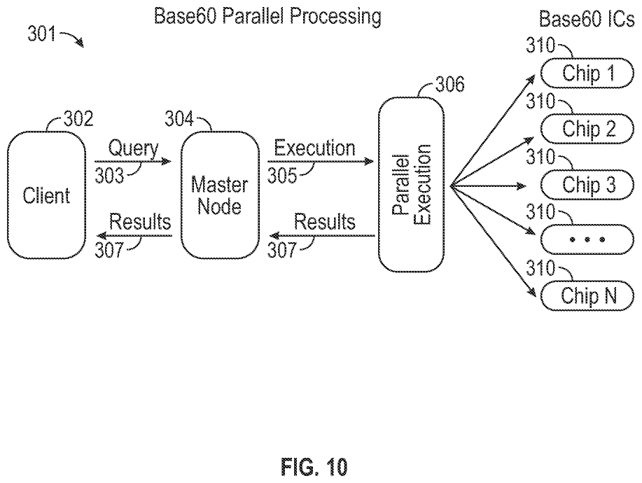

Turning to FIG. 10, an exemplary system 301 works in Multiple Instruction, Multiple Data (MIMD) parallel processing operation flow. As a computer system it has multiple Base 60 processors, each capable of accepting its own instruction stream independently from the others. Each processor also pulls data from a separate data stream. The MIMD computing system 301 executes several different processes at once. The system can be set up with advanced algorithms for most efficient operation. The client 302 (computing system, CPU, GPU) sends a request for Arithmetic or Logic operation (Query 30:3) to the Master Node 304. Master Node 304, which is a Base 60 chip, in executing 305 the query, checks for parallel processing option existence 306. If the option exists, the operation is split to many (virtually endless via network) chips 310 for parallel processing according to MIMD flow. The operation is executed in parallel on all chips as the master chip is the conductor. Finally, the results 307 return to the Master node 304 (Chip) and from there to the client 302.

Thus, it is seen that sexagesimal-native electronic architecture, semiconductor devices, and methods are provided which natively perform operations and flows using a numeral system having sixty as its base. It should be understood that any of the foregoing configurations and specialized components or connections may be interchangeably used with any of the systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the present disclosure.

What is claimed is:

1. A sexagesimal-native electronic architecture, comprising:
a sexagesimal-native semiconductor unit natively performing operations and flows using a numeral system having sixty as its base;
wherein the sexagesimal-native semiconductor unit is configured to communicate with semiconductor units that perform operations and flows using one or more of: decimal and binary number systems.

2. The sexagesimal-native electronic architecture of claim 1 wherein the sexagesimal-native semiconductor unit is one or more of: an integrated circuit, an arithmetic logic unit, a central processing unit, a microcontroller, or a microchip.

3. The sexagesimal-native electronic architecture of claim 2 wherein the sexagesimal-native semiconductor unit comprises an arithmetic unit and a logic unit and operations and flows include arithmetic calculations and logic operations.

4. The sexagesimal-native electronic architecture of claim 1 wherein the sexagesimal-native semiconductor unit comprises a first arithmetic unit configured to perform arithmetic operations and a second arithmetic unit configured to perform floating-point arithmetic operations.

5. The sexagesimal-native electronic architecture of claim 1 wherein the sexagesimal-native semiconductor unit comprises a plurality of arithmetic logic units working in parallel.

6. The sexagesimal-native electronic architecture of claim 1 wherein op-codes are stored and processed internally using the numeral system.

7. The sexagesimal-native electronic architecture of claim 1 further comprising a three-dimensional multi-planar silicon structure.

8. The sexagesimal-native electronic architecture of claim 1 further comprising one or more of: an onboard memory unit, a microcontroller unit, low power circuitry, a register, an I/O unit, a clock generator, or a power management unit.

9. The sexagesimal-native electronic architecture of claim 1 further comprising at least one bipolar transistor and at least one field-effect transistor.

10. The sexagesimal-native electronic architecture of claim 9 wherein one or both of the at least one bipolar transistor and at least one field-effect transistor forms digital analog or mixed signal circuits.

11. A sexagesimal-native integrated circuit performing operations using a Base 60 numeral system and being configured to communicate with integrated circuits that perform operations using one or more of: decimal and binary number systems.

12. The sexagesimal-native integrated circuit of claim 11 comprising a Base 60-native integer computing system.

13. The sexagesimal-native integrated circuit of claim 12 further comprising a Base 60-native fixed-point computing system.

14. A sexagesimal numeral method, comprising:
providing a sexagesimal-native arithmetic operation unit performing mathematical operations using a numeral system having sixty as its base;
natively processing and representing all numbers as sexagesimal numbers; and
communicating with separate arithmetic operation units that perform mathematical operations using one or more of: decimal and binary number systems.

15. The sexagesimal numeral method of claim 14 wherein the sexagesimal-native arithmetic operation unit is configured to communicate with other arithmetic operation units in parallel processing mode.

16. The sexagesimal numeral method of claim 15 wherein the sexagesimal-native arithmetic operation unit works in operational levels including a first level being a read operation and a last level being an output/write operation.

17. The sexagesimal numeral method of claim 14 wherein the sexagesimal-native arithmetic operation unit is configured to convert the numeral system to one or more of: a decimal system and binary system; and
wherein the sexagesimal-native arithmetic operation unit is configured to convert either of the decimal system and the binary system back to the numeral system having sixty as its base.

18. The sexagesimal numeral method of claim 14 further comprising storing input and output data in one or more registers as high or low voltage levels.

19. The sexagesimal numeral method of claim 18 further comprising a memory buffer generating a drive level on the one or more registers.

20. The sexagesimal-native electronic architecture of claim 1 further comprising:
a write bus;
one or more registers; and
a memory buffer communicatively connected to the write bus between the semiconductor unit and the one or more registers.
